(19) United States
(12) Patent Application Publication
(10) Pub. No.: US 2007/0221272 A1
(43) Pub. Date: Sep. 27, 2007

(54) Water hose purging device

(76) Inventor: David Apsley, Star, ID (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 11/391,131

(22) Filed: Mar. 27, 2006

(51) Int. Cl. F16K 11/00

(52) U.S. Cl. 137/240

(57) ABSTRACT

A liquid line purging device includes a self-contained liquid line coupling mechanism and internal check valve system, and may be fitted, for example, to any existing home garden hose or field water supply system. Also, the device has a gas fitting, for receiving purging gas, typically air, which flows into the device, up against the check valve system, and out the liquid line to remove liquid from it. The purging device may be left connected to the hose system, and when used as described, prevents freezing of piping and hoses during sub-freezing weather.

### BACKGROUND OF THE INVENTION

1. Field of the Invention

The present invention relates to a water hose purging device, and more particularly to a water hose purging device that is self contained and is capable of cooperating with existing water hoses and valves.

2. Related Art

The use of the invented device would be readily recognized as an extremely practical scenario in any region where temperatures regularly fall below freezing and the possibility of frozen pipes and hoses and the potential breakage of same and ensuing damage is a common occurence.

U.S. Pat. No. 3,845,779, Greene, Jr./Waldon Devices, Inc. address the use of a device connectedly interposed between a water faucet and a garden hose, into which pressurized air may be introduced to evacuate water from the hose. However, no means is provided within this device to prevent pressurized air from reaching internal portions of the water faucet valve and associated piping, unlike the present invented device wherein pressurized air may only flow toward the connected hose. Additionally, this U.S. Pat. No. 3,845,779 makes no mention of use of the invention therein in conjunction with frost-free hose connections.

### SUMMARY OF THE INVENTION

The present invention relates generally to purging devices used to evacuate water from a water supply or drain line, especially a garden hose.

The present invention may be used with building water connections that are of the non frost-free or frost-free types and functions equally well with either type. Preferably, the invented device would be used primarily with the frost-free type of building connection, as this is the type of hose valve most commonly used in regions where sub-freezing temperatures are regularly encountered and where a device of the nature of the invented device would most commonly be employed. Many other uses are also contemplated. For example, the present invention may be used with anti-siphon hose bibs, and with drains for campers and RV's.

The typical frost-free hose connection is comprised of a shut-off valve approximately 12 inches or more within a building, with the operating means (valve wheel), and means for connection of a hose, located outside the building. The frost-free connection, with its water shut-off within the building, prevents freeze-up of water within the piping, as the water remains above freezing temperature due to surrounding heat within the building.

Typically, a home garden hose is left connected to a frost-free spigot and is coiled upon a bracket attached to the side of the building for this purpose. Even though water flow has been shut off, the frost-free valve and hose remain at least partially full of water. Because the hose has been left connected to the valve, the valve does not have the opportunity to drain, thereby eliminating its frost-free capability. Should the hose and valve be subjected to freezing temperatures, the water left within may freeze and expand, with the possibility of pipe breakage and ensuing building flooding and water damage.

Use of the present invention in conjunction with pressurized air allows a garden hose to remain connected to the building in any season and yet prevents freezing of the piping.

The present invention comprises a valve body, with female threads in one first end, used to connect the valve body to, for example, an existing garden hose building connection. The opposite, second end of the valve body comprises a male thread designed to accept the female threaded connection of a garden hose. The present invention is provided with a fitting to admit pressurized air to the interior of the valve body.

Within the valve body is a slideably moveable check valve used to automatically direct the flow of air or water, the position of the check valve being dependent upon the introduction of water pressure or air pressure to the valve body.

Preferably, the components of the invention are made of suitably strong, lightweight, pressure and moisture resistant materials as needed to perform the functions required.

The preferred embodiment of this invention is depicted as being used for home garden hoses, however, the invention is not limited to garden hose systems and may be adapted for use with other types of hose systems and with liquids other than water.

### BRIEF DESCRIPTION OF THE DRAWINGS

FIG. 1 is a perspective view of one, second end of one embodiment of the present invention.

FIG. 2 is a perspective view of the opposite, first end of the embodiment depicted in FIG. 1.

FIG. 3 is an exploded perspective view of the embodiment depicted in FIG. 1.

FIG. 4 is a cross-sectional elevation view along the line 4-4 in FIG. 8 of one embodiment of the present invention, showing the check valve in position for water flow.

FIG. 5 is a cross-sectional plan view of the embodiment depicted in FIG. 4.

FIG. 6 is a cross-sectional elevation view along the line 6-6 in FIG. 9 of the embodiment depicted in FIG. 4, showing the check valve in position for air flow.

FIG. 7 is a partial perspective view of one embodiment of the front section of the present invention, showing the female end (see also the right hand side end of FIG. 3).

FIG. 8 is an elevation view of the embodiment depicted in FIG. 4, showing the female end.

FIG. 9 is an elevation view of the embodiment depicted in FIG. 4, showing the male end.

FIG. 10 is a cross-sectional elevation view along the line 10-10 in FIG. 5, showing the air passages in the check valve.

FIG. 11 is a cross-sectional elevation view along the line 11-11 in FIG. 5, showing the water passages in the valve bulkhead.

FIG. 12 is a side elevation view showing one embodiment of the present invention in the installed configuration.

FIG. 13 is a cross-sectional side elevation partial view showing the embodiment depicted in FIG. 12 in the installed configuration.

FIG. 14 is a perspective view of the female first end according to a second embodiment of the present invention.

FIG. 15 is a partial perspective view of the front section of the embodiment depicted in FIG. 14.

FIG. 16 is an exploded perspective view of the embodiment depicted in FIG. 14.

FIG. 17 is a cross-sectional elevation view of the embodiment depicted in FIG. 14.

FIG. 18 is an end elevation view according to a second embodiment of the present invention.

FIG. 19 is an end elevation view according to a second embodiment of the present invention, depicting the rotational capability of the connection fitting.

FIG. 20 is a partial cross-sectional elevation view of the dotted circle of the embodiment depicted in FIG. 17.

### DESCRIPTION OF THE PREFERRED EMBODIMENTS

Referring to the Figures, there are shown two, but not the only two, embodiments of the invented water hose purging system that may be used to evacuate water from a hose, thereby preventing freezing of the water left in the hose and associated piping in a winter environment. Use of the invented device also allows the hose to remain connected to building piping but eliminates the danger of frozen and broken hose or piping.

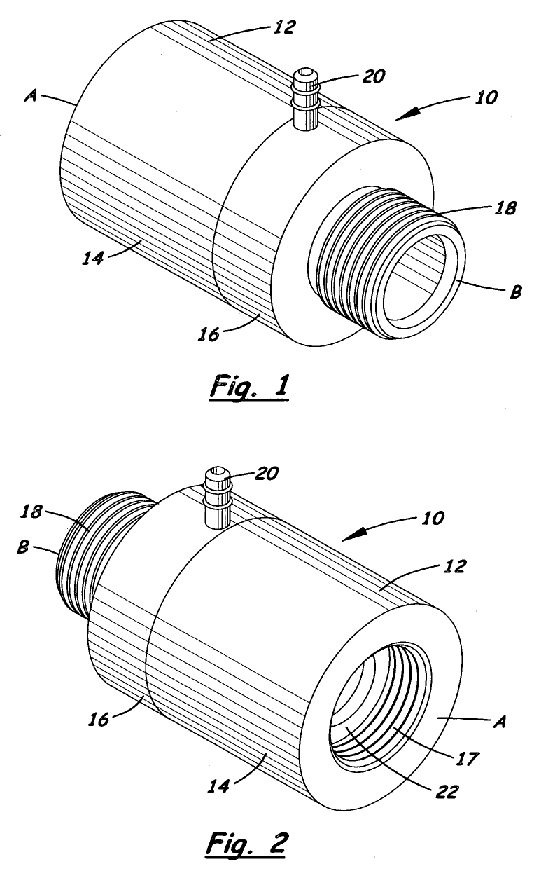

Referring now to FIGS. 1 and 2, the preferred hose purging device comprises of a valve assembly 10. Valve assembly 10 has of valve body 12, comprised of valve portions 14 and 16, and female end A and male end B. In the preferred embodiment, valve body 12 is comprised of portions 14 and 16 to allow convenient assembly. Valve portions 14 and 16 are preferably made of high strength plastic and are permanently joined at assembly with suitably strong, waterproof adhesive applied to joining surfaces 42 and 44 and pilot diameter 24. Other assembly methods, such as threads and seals, but not limited to same, may be employed to join the two valve housing portions 14 and 16 of valve body 12.

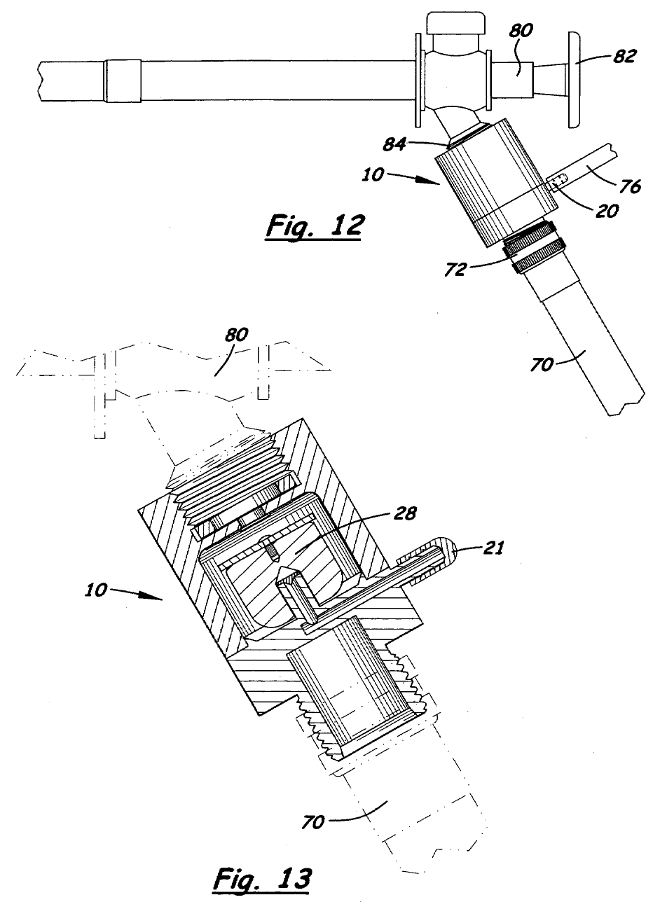

Contained within portion 14 at end A of valve body 12 are integrally molded female threads 17 of a suitable size and pitch to enable the valve assembly 10 to be threaded, for example, upon a typical building hose valve connection 80. (See FIG. 12).

Molded integrally upon an outer diameter of valve portion 16 at end B of valve body 12 are male threads 18 of a suitable size and pitch to allow for the connection of, for example, a typical garden hose 70 using the female connector 72. (See FIG. 12). In the preferred embodiment, air fitting 20 is integrally molded upon an outer diameter of valve housing portion 16, and is of the barbed type to accept an air hose 76. Air fitting 20 may also employ, but is not limited to, a threaded fitting connection or one of the “quick-connect” type fittings that are standard in pressurized air connections.

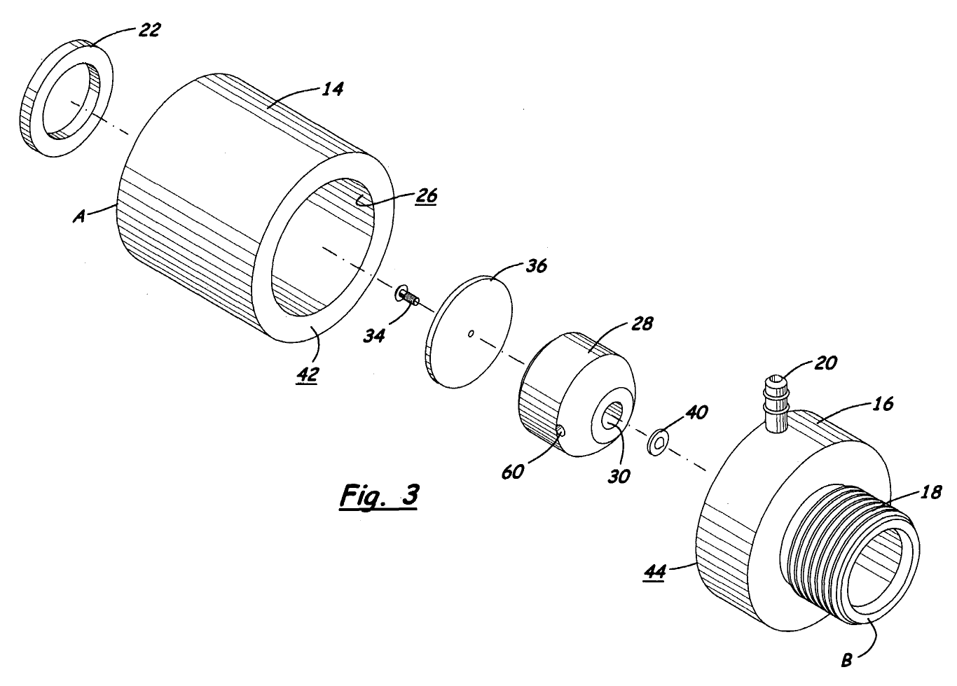

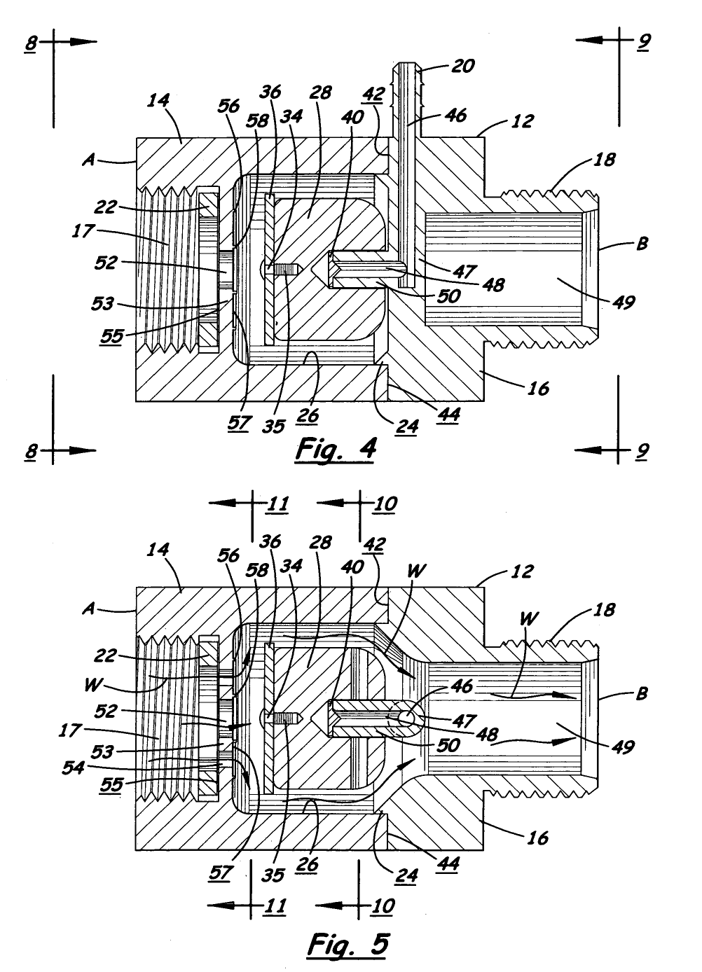

Referring now to FIGS. 3 and 4, gasket 22 is housed within valve portion 14 and is preferably comprised of a flexible, resilient, waterproof material such as rubber or similar compound. Gasket 22 is removable and replaceable as in, for example, a standard garden hose and is used to form a watertight seal when valve assembly 10 is threaded upon threads 84 of building valve 80. (See FIG. 12).

Referring now to FIGS. 5 and 7, it will be seen that tubes 47 and 50, containing air passages 46 and 48, are integrally molded within valve housing portion 16. Check valve 28 is mounted upon tube 50 using bore 30 (see FIG. 3), and is designed to move left and right. Pilot diameter 24 of valve housing portion 16 is used to obtain suitable alignment with interior diameter 26 of valve housing portion 14 during assembly.

Referring now to FIGS. 4 and 11, valve housing portion 14 contains integrally molded bulkhead 53, comprised of surfaces 55 and 57. Surface 55 forms a sealing surface for gasket 22. Upon surface 57 are integrally molded raised sealing rings 56 and 58. Surface 57 and sealing rings 56 and 58 form a sealing surface for seal 36 of check valve 28. Bored through bulkhead 53 are central water passage 52 and radial water passages 54.

Referring now to FIGS. 3 and 4, seal 36, made of a suitably strong, flexible, resilient, waterproof material, is attached to one end of check valve 28 utilizing screw 34 and correspondingly threaded hole 35 in check valve 28. Bore 30 is contained in the opposite end of check valve 28 and centered within its diameter, and is constructed such that it may slide upon tube 50 of valve housing portion 16. Seal 40 is contained within bore 30 and is constructed of a suitably strong, flexible, resilient, waterproof material. Bored perpendicularly to bore 30 are air passages 60. (See FIG. 10).

Referring now to FIGS. 4 and 5, valve assembly 10 is shown in water flow mode. Check valve 28 has been moved to the right toward end B of valve assembly 10 by the pressure of water entering valve assembly 10 through end A. Water flow through valve assembly 10 is indicated by arrows W. Water under pressure flows through valve body 12, around tube 47 and out into the atmosphere or a connected garden hose through passage 49. Seal 40, contained within bore 30 of check valve 28, is compressed and held by the movement of check valve 28, against end 51 of tube 50, thereby sealing air passage 48 within tube 50 against the entry of water into air passage 48.

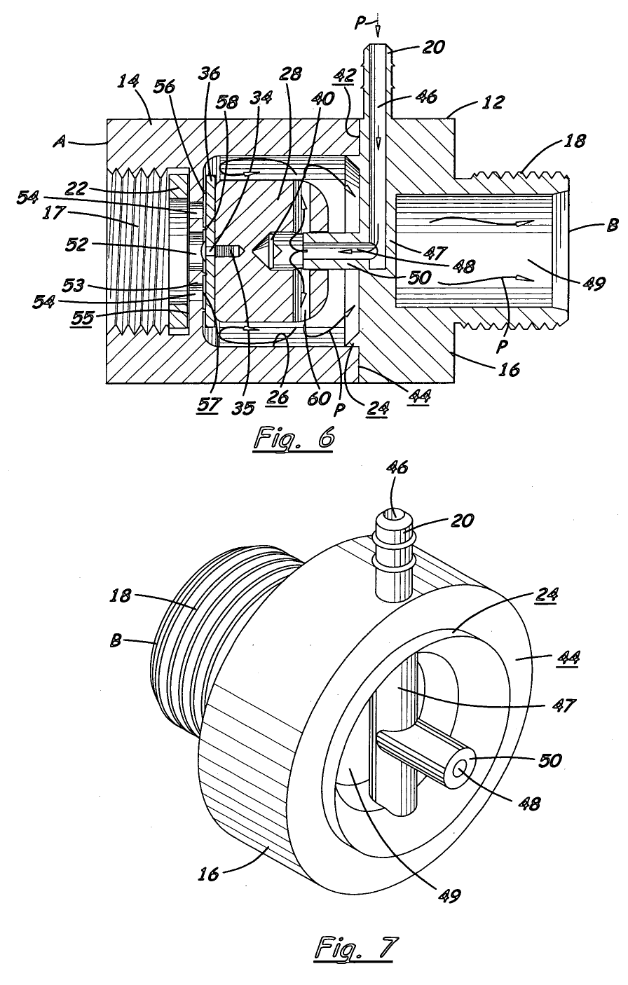

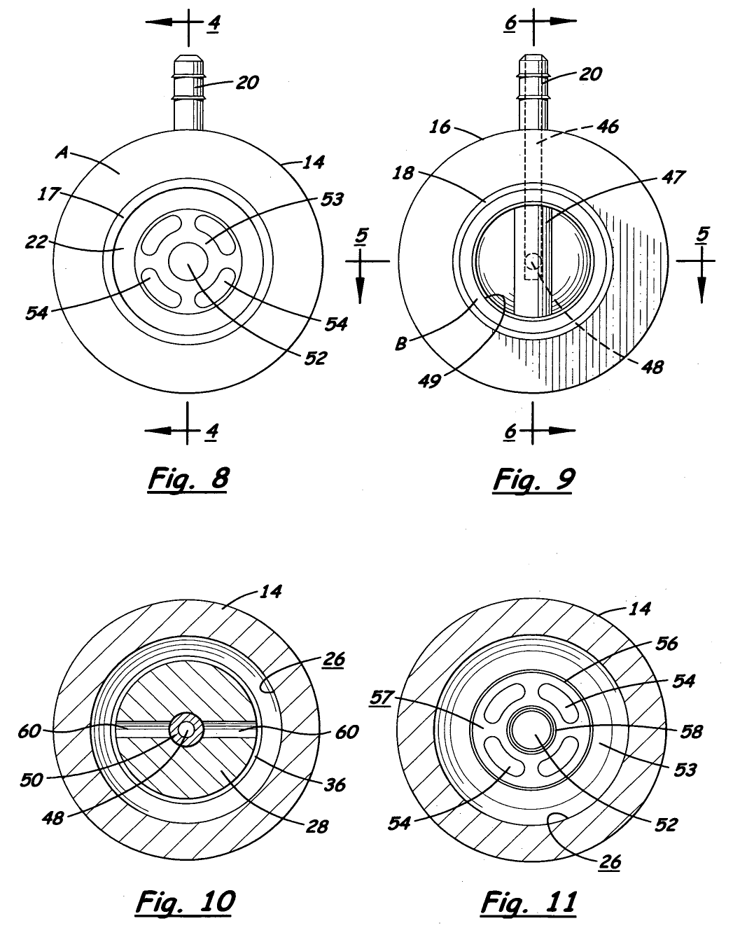

Referring now to FIG. 6, valve assembly 10 is shown in air flow mode. Water pressure and flow has been eliminated from valve assembly 10 using building valve 80. (See FIG. 12). Check valve 28 has been moved to the left toward end A of valve assembly 10 by pressurized air entering valve assembly 10 at air fitting 20. Pressurized air, indicated by arrows P, flows through air passages 46 and 48, and upon reaching seal 40, moves check valve 28 to the left, forcing seal 36 against surface 57 and sealing rings 56 and 58 of bulkhead 53, thereby sealing water passages 52 and 54, preventing pressurized air from entering water passages 52 and 54, and thence building valve 80 and associated building piping. It may be seen that as check valve 28 moves left toward end A of valve assembly 10, air passages 60 in check valve 28 are exposed to air flow, whereupon pressurized air flows through passages 60 into the interior of valve body 12, around tube 47, and out through passage 49 and into a connected hose. Pressurized air within the hose forces any water remaining in the hose out through its open end. Air hose 76 may be disconnected from air fitting 20 when pressurized air is no longer required.

Referring now to FIGS. 12 and 13, the position and angularity of the installed preferred embodiment may be seen. When no air or water pressure is contained within valve assembly 10, check valve 28, due to its own weight, is free to move downwardly upon tube 50 toward end B of valve assembly 10. Water passages 52 and 54 are now open to water flow, and thus any water remaining within building valve 80 and associated piping is allowed to drain into hose 70, thereby preventing freezing of said water within building valve 80 and associated building piping. Optionally, a suitable cap 21 may be used to cover fitting 20 and air passage 46 when an air hose is not connected to fitting 20.

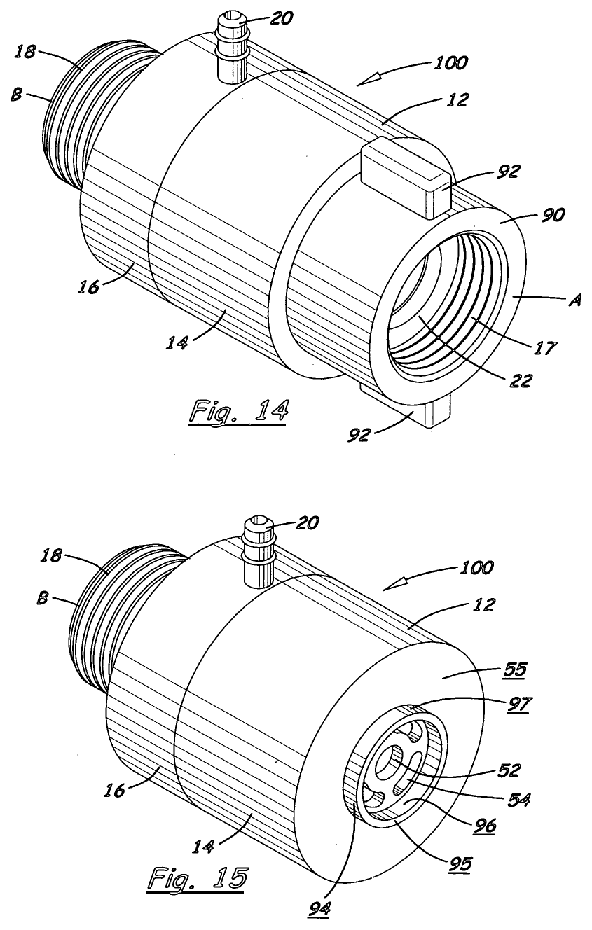

Referring now to FIGS. 14 through 20, in a second preferred embodiment 100 of the invented device, a rotatable fitting is provided at end A. In this second embodiment, valve body 12 provides a joining means wherein fitting 90 at end A is securely and permanently fastened to valve body 12, yet is freely rotatable through 360 degrees in either direction. After fitting 90 is connected to a building water connection, end B of valve body 12 may be rotated upon fitting 90 to allow air fitting 20 to be rotated to the most desirable position to receive air hose 76. Modes of operation and flow of air and water remain the same as previously described.

Referring now to FIG. 14, it may be seen that end A of valve assembly 100 is provided with a rotatable female threaded connection fitting 90, which is permanently affixed to valve body 12 and may be used to connect valve assembly 100 to a building water connection 80. After fitting 90 and attached valve body 12 are threaded upon a building water connection, end B of valve assembly 100 may be rotated to any desired position to facilitate convenient connection of a purging air hose 76 to fitting 20.

Referring now to FIG. 15, it may be observed that annular raised ring 94 is integrally molded upon surface 55 of valve body 12. Ring 94 is comprised of inner surface 96, outer surface 97, and sealing surface 95.

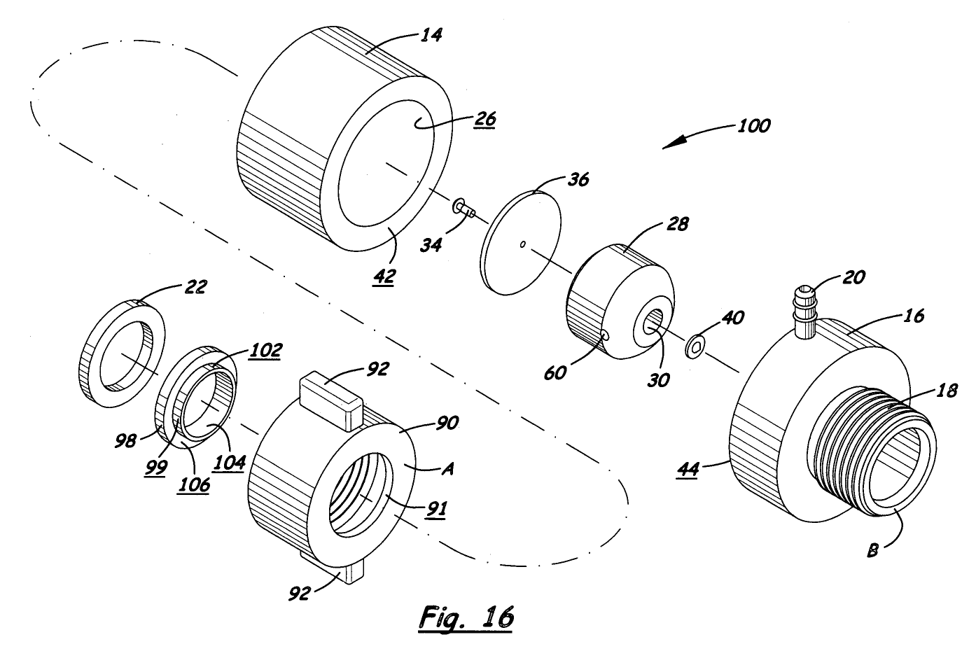

Referring now to FIG. 16, it will be seen that locking ring 98 comprises raised annular ring 99, which contains outer surface 102. Locking ring 98 also contains interior passage 104 and sealing surface 106. Fitting 90 may be seen to contain annular bearing surface 91 and knobs 92. Knobs 92 provide gripping surfaces for the fingers, to aid in making a tight threaded connection to a building water connection.

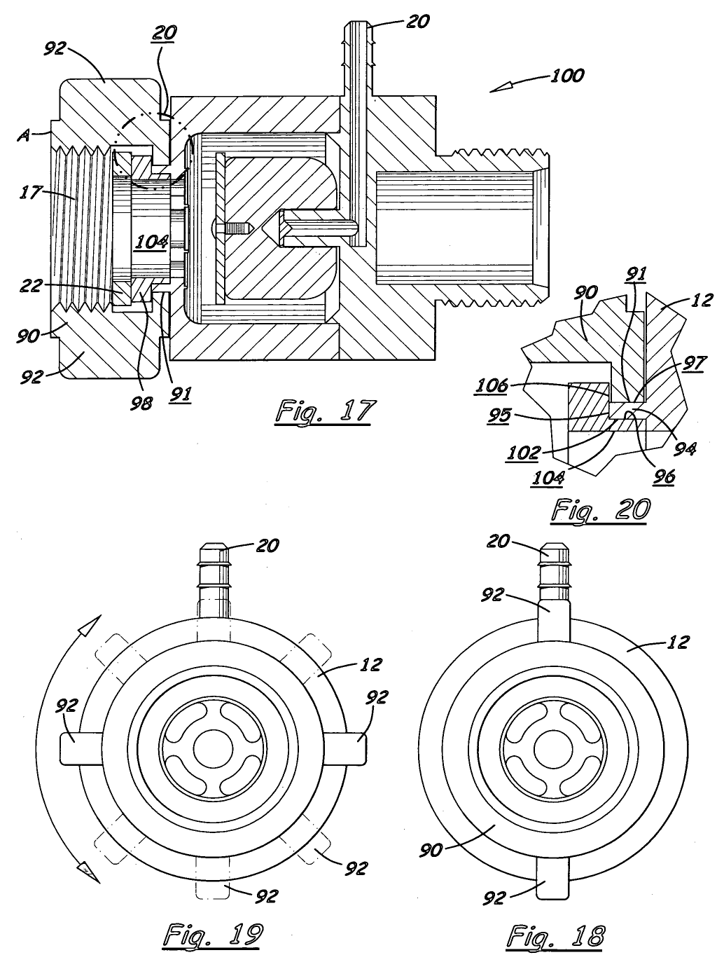

Referring now to FIG. 17 and FIG. 20, it may be observed that fitting 90 is assembled to valve body 12 so that bearing surface 91 of fitting 90 rests upon surface 97 of annular raised ring 94 of valve body 12. Surface 91 is free to rotate upon surface 97. Locking ring 98, preferably made of the same plastic compound as the other plastic valve components, with appropriate bonding adhesive applied to surfaces 102 and 106, is now positioned so that surface 102 of locking ring 98 mates with surface 96 of annular ring 94 and surface 106 of locking ring 98 mates with surface 95 of annular ring 94, thereby creating a permanent bond whereby fitting 90 may rotate freely with respect to valve body 12 but may not be removed from valve body 12. When fitting 90 is threaded upon a building water connection, gasket 22 is compressed between the threaded end of the building water connection and locking ring 98, thereby allowing water flow only through interior passage 104 in locking ring 98, and hence into valve body 12.

Although this invention has been described above with reference to particular means, materials and embodiments, it is to be understood that the invention is not limited to these disclosed particulars, but extends instead to all equivalents within the scope of the following claims.

I claim:

1. A liquid distribution line purging system comprising,
a valve body with two ends, the first end thereof being adapted to be connected to a liquid supply line, and the second end thereof being adapted to be connected to the proximal end of said liquid distribution line, said valve body also having an internal check valve assembly, and said valve body having a liquid flow path into said valve body from said liquid supply line, and out to said liquid distribution line, and around and past said check valve assembly within said valve body, and,
said valve body also having a gas fitting and a gas flow path into said valve body from said gas fitting and out to said liquid distribution line, and against, but not past, said check valve assembly within said valve body.

2. The purging system of claim 1 wherein the liquid is water.

3. The purging system of claim 1 wherein the gas is air.

4. A method for purging a liquid distribution line comprising,
providing a valve body on or in the liquid distribution line, the valve body having two ends, the first end thereof being adapted to be connected to a liquid supply line, and the second end thereof being adapted to be connected to the proximal end of said liquid distribution line, said valve body also having an internal check valve assembly, and said valve body having a liquid flow path into said valve body from said liquid supply line, and out to said liquid distribution line, and around and past said check valve assembly within said valve body; and,
said valve body also having a gas fitting and a gas flow path into said valve body from said gas fitting and out to said liquid distribution line, and against, but not past, said check valve assembly within said valve body.

5. The purging method of claim 4 wherein the liquid is water.

6. The purging method of claim 4 wherein the gas is air.
